(19) United States
(12) Patent Application Publication
(10) Pub. No.: US 2014/0136554 A1
(43) Pub. Date: May 15, 2014

(54) SYSTEM AND METHOD FOR RECOMMENDING TIMELY DIGITAL CONTENT

(71) Applicant: NATIONAL PUBLIC RADIO, INC., Washington, DC (US)

(72) Inventors: Javaun MORADI, Alexandria, VA (US); Demian PERRY, Arlington, VA (US); Michael YOCH, Washington, DC (US); Jared BIEHLER, Falls Church, VA (US)

(73) Assignee: NATIONAL PUBLIC RADIO, INC., Washington, DC (US)

(21) Appl. No.: 13/676,708

(22) Filed: Nov. 14, 2012

(51) Int. Cl. G06F 17/30

(52) U.S. Cl. CPC G06F 17/30029
USPC 707/754

(57) ABSTRACT

Embodiments include methods, systems, and non-transitory computer program products for recommending timely digital content to a user. The method includes receiving a request for a digital content recommendation for a content channel, and selecting a content collection from content collections associated with the content channel, where the content collection contains pre-selected digital content. The method also includes determining digital content candidates from the selected content collection based on pre-determined editorial rankings of digital content candidates or recently popular digital content among users. The method also includes filtering the digital content candidates to determine at least one recommended digital content candidate, where the filtering is based on a length of a digital content candidate, a date and time associated with the digital content candidate, or whether the user has previously consumed the digital content candidate. The method also includes sending the recommended digital content candidate to a client device.

### FIELD OF THE DISCLOSURE

The present disclosure relates generally to digital content recommendation systems. In some embodiments, the present disclosure relates to digital content recommendation systems for timely, or current, broadcast programming such as talk radio news and news stories.

### BACKGROUND

A radio broadcast system generally allows listeners to listen to mass terrestrial broadcasts of news, talk shows, interviews, and cultural content. Editorial recommendations traditionally affect the content being broadcast. For instance, editors often choose and prioritize content that they believe are likely to be interesting and compelling to a mass audience of listeners.

As the popularity and use of the Internet has increased, online systems have been developed that allow users to download or receive digital content for music, books, movies, etc. Some online systems process demographic and other data to try to determine user preferences and recommend music, books, or movies in which users might be interested. In some instances, the systems utilize “collaborative filtering” for recommending digital content to users. With collaborative filtering, the system collects preferences, tastes, demographic information, and/or other information from many users, analyzes this information, and automatically recommends digital content to one or more users based on the information.

### SUMMARY

In accordance with the disclosed subject matter, methods, systems, and non-transitory computer program products are provided for recommending timely digital content to a user.

Certain embodiments include a computer-implemented method for recommending timely digital content to a user. The method can include receiving a request for a digital content recommendation for a content channel. The method can also include selecting a content collection from a plurality of content collections associated with the content channel, where the content collection contains a plurality of pre-selected digital content. The method also includes determining a plurality of digital content candidates from the selected content collection based on at least one of pre-determined editorial rankings of digital content candidates and recently popular digital content among a plurality of users. The method can also include filtering the plurality of digital content candidates to determine at least one recommended digital content candidate, where the filtering is based on at least one of a length of a digital content candidate, a date and time associated with the digital content candidate, and whether the user has previously consumed the digital content candidate. The method also includes sending the recommended digital content candidate to a client device. In addition, the present disclosure is also directed to systems and non-transitory computer program products for recommending timely digital content to a user.

### BRIEF DESCRIPTION OF THE FIGURES

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIG. 1 illustrates a non-limiting example of a system for delivering personalized content recommendations to the user in accordance with some embodiments of the present disclosure.

FIG. 2 illustrates an example of a process that the system performs for recommending personalized content to a user of a connected device.

FIG. 3 illustrates an example of the process that the system uses to determine whether to apply a news update override.

FIG. 4 illustrates an example of the process that the system performs for selecting content collections.

FIG. 5 illustrates an example of the process that the system performs for determining a list of story candidates for a selected content collection.

FIG. 6 illustrates an example of the process that the system performs for filtering story candidates.

FIG. 7 illustrates an example of a screenshot of a user interface for consuming recommended digital content.

FIG. 8 illustrates an example of a screenshot of a user interface for displaying listening, receipt, or consumption history of content.

FIGS. 9A-9B illustrate examples of screenshots of a user interface for blending national and local content.

FIG. 10 illustrates an example of a screenshot of a user interface that is displayed on a user's connected device when a news override story is received.

FIG. 11 illustrates an example of a screenshot of a user interface of a connected device 104 for a multichannel user experience.

FIG. 12 illustrates an example of a screenshot of a user interface for a music listening channel.

FIG. 13 illustrates an example of a user interface for a configuration tool for configuring channels.

### DETAILED DESCRIPTION

In general, the present disclosure relates to a system and method that allows a user to use a connected device, such as a computer, to connect to a network, such as the Internet. After the device is connected, the user can select a digital “channel” and listen to a recommended audio story or broadcast segment from the selected channel. For example, if the user selects a channel about technology, the present system can recommend and play a radio news story about robots trading on the stock market. In one implementation, an editor of the system pre-configures these channels with “collections” or categories of digital content. Examples of content collections may include collections of news stories and broadcast segments categorized by radio show, such as collections of broadcast segments originally aired on the radio shows All Things Considered, Morning Edition, or Talk of the Nation. Other content collections may include collections of news stories and broadcast segments categorized by genre, author, etc.

As described earlier, an editor may pre-configure channels with a number of content collections. The system selects a pre-configured content collection from the user's selected channel and determines a list of story candidates from the selected content collection. The system then selects one or more of the story candidates from the list to be the recommended story or stories. Then, the recommended story or stories is sent to the user's connected device.

In some implementations, the system selects a content collection in a channel and determines story candidates from among various stories in the content collection to recommend as the selected story to the user. The content collection can be selected based on pre-determined editorial rankings of stories in the collection, or based on stories in the collection which are trending popular among a number of other listeners. If the system uses trending popularity, it may filter the story candidates based on collaborative filtering, such as selecting or preferring content which other listeners have rated highly. The system then removes or filters the story candidates based on additional factors such as freshness, duration, and user history to recommend a candidate story or stories and sends the recommended story candidate(s) to the user's connected device.

The system and method may utilize editorial judgment, news cycle timeliness, personal tastes, shared experiences, local relevancy, popularity of the content, ratings from other users, and discovery to recommend digital content. Editorial judgment refers to an editor's assessment or determination of what content will be compelling to a large audience of listeners or users. However, not all editor-recommended content will be compelling to all users. Personal tastes refer to content thought to be compelling to an individual user, at the expense of suggesting a narrower range of stories to the user. Accordingly, the present system combines editor recommendation with personal recommendation and popularity. News cycle timeliness and news judgment prioritize top stories of the day by importance, not merely mass popularity, in pursuit of a more informed public. News cycle timeliness also takes into consideration how current or old the content is. Shared experiences refer to a feeling of connectedness to others for having listened to, watched, or reviewed the same memorable or poignant content. To create a shared experience, stories, for example, may be heard by a wide audience at approximately the same time. Local relevancy refers to a characteristic or quality of content that causes users to feel more connected to their communities and to the media serving them. Popularity of the content refers to content considered interesting to a number of users. Similarly, ratings from other users refers to recommending content rated highly by other users, whether many users rate the content highly, or whether another user, with tastes similar to the user requesting the content, rates the content highly. Discovery refers to a process of being serendipitously exposed to unexpected ideas and perspectives. Although this example has described recommending radio news segments, the present system can be used for other types of digital content, non-limiting examples of which are described in more detail below and may include news, talk radio, and cultural and music content.

The present system and method can be used to create a continuous audio or video broadcast stream based on individual segments, such as story recommendations. The present system can also create a magazine-like browsing experience by aggregating text stories or other multimedia content that a user can display and review on a computer or other connected device.

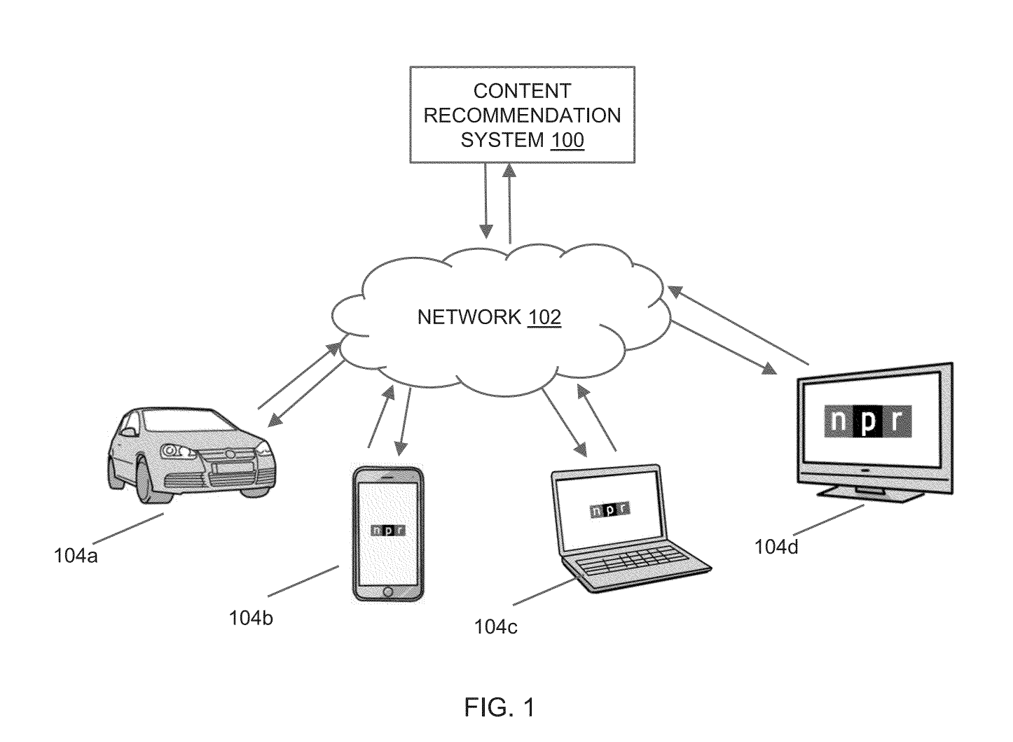

Turning to the figures, FIG. 1 illustrates a non-limiting example of a system 100 for delivering personalized content recommendations to the user in accordance with some embodiments of the present disclosure. As shown, various connected devices 104a-104d can communicate with the content recommendation system 100 over a network 102 (e.g., the Internet). A “connected device” is a device that is capable of connecting to the network 102 and receiving digital content. Examples of a connected device may include a “connected car” 104a (which can “connect” to the network 102), a mobile phone 104b, a computer 104c, connected TV 104d (which can “connect” to the network 102), a tablet (not shown), or any other connected device. A user of a connected device can initiate a content session with the system 100 to select a content channel and request a content recommendation.

Although the network 102 is illustrated as a single network, it may comprise one or more networks. For example, the network 102 may establish a computing cloud (e.g., software implementing the system 100 is hosted by a cloud provider and exists “in the cloud”). Moreover, the network 102 can be a combination of public and/or private networks, which can include any combination of the Internet and intranet systems that allow the devices 104a-104d to access and communicate with the content recommendation system 100. For example, the network 102 may comprise the Internet, a local area network (“LAN”) (such as an Ethernet or Wi-Fi network), a wide area network (“WAN”) (such as a LAN-to-LAN via Internet tunneling), or a combination thereof. The network 102 may also use electrical cable (such as HomePNA or power line communication), optical fiber, or radio waves (such as wireless LAN or satellite communications) to transmit data. The content recommendation system 100 and the devices 104a-104d may use standard Internet protocols for communication (e.g., TCP/IP (Transmission Control Protocol/Internet Protocol) and HTTP (Hyper-Text Transfer Protocol)). In some embodiments, the system 100 may be connected to the network 102 using a wired connection to the Internet. Of course, the specific examples above are merely possible implementations of the system 100, network 102, and devices 104a-104d and are not intended to be limiting.

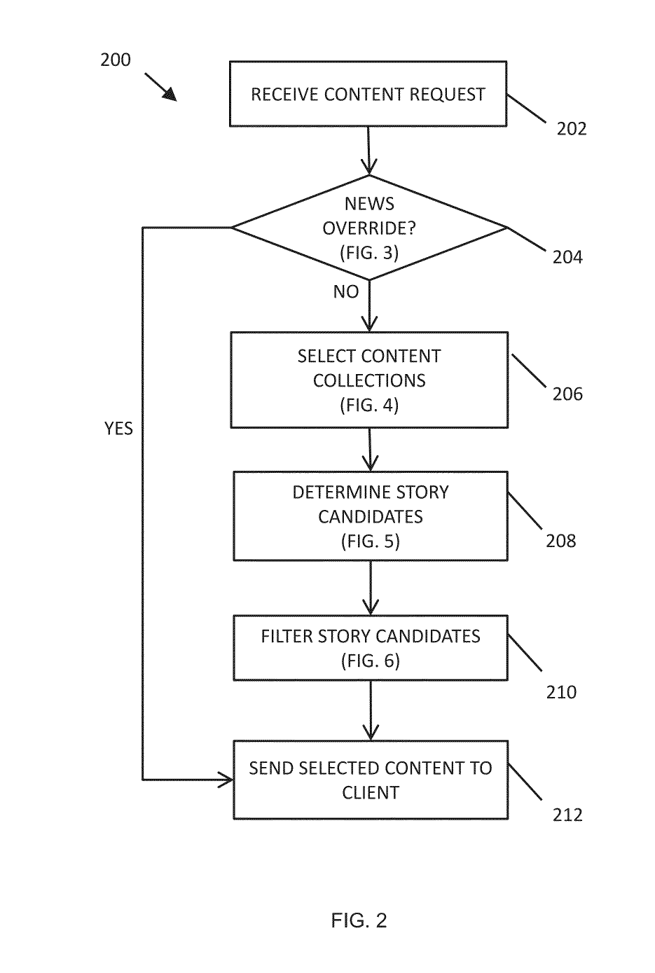

FIG. 2 illustrates an example of a process 200 that the system 100 performs for recommending personalized content to a user of a connected device 104a-104d. In one implementation, the system 100 receives a content request for a content channel that the user selects via a connected device 104 (step 202). For example, the user can select a channel of interest, such as a news channel, a news and variety channel, a conversations/interview channel, a music discussion channel, a music listening channel, an arts and life channel, or a television/movie channel. After the user selects the channel, the system 100 recommends digital content for the user. In one embodiment, the system 100 allows editors to create channels according to programming and audience research, content affinity score, listening mood, format, and desired channel style. Programming and audience research includes conversations and focus groups with listeners and consumers of competitive media that discover qualitative connections between otherwise seemingly disparate content. Content affinity score measures interest that an audience of one radio program might have in the content of another radio program. Content affinity score can be based on listener surveys. Listening mood measures how an individual's content preferences change based on time of day, day of the week, or other factors. Format refers to a broad content categorization often associated with an entire channel or radio station. For example, some radio stations can be considered classical music stations and other stations can be considered talk format stations. Desired channel style refers to rules that editors or administrators apply to content, such as a desired length of all stories in a channel, the immediacy or timelessness of the content, and the appropriateness of an interruption for updated content, such as breaking news or a live concert. A content channel contains a collection of one or more pieces of digital content, such as a collection of songs, news programs, video segments (e.g., television shows or movies), etc. Content channels can be continuous sequences of digital content segments aggregated by an editor so as to provide an enjoyable user experience in a cohesive and meaningful manner.

After receiving the content request, the system 100 determines whether a “news override” is required (step 204). In one implementation, a news override is a newsworthy story that has a higher priority than the digital content to be recommended to the user. Examples of a news override may include a breaking news update or an emergency broadcast message. In other embodiments, the news override may not necessarily have a higher priority than the recommended digital content and may include hourly or periodic news or live coverage of a news event. The system 100 may only determine whether a news override exists if the system 100 is configured to provide such overrides. For instance, the editor for the system 100 may selectively configure the system to provide hourly news updates, or the user may request such hourly updates. Moreover, overrides are not limited to news and may constitute other types of programming, content, etc.

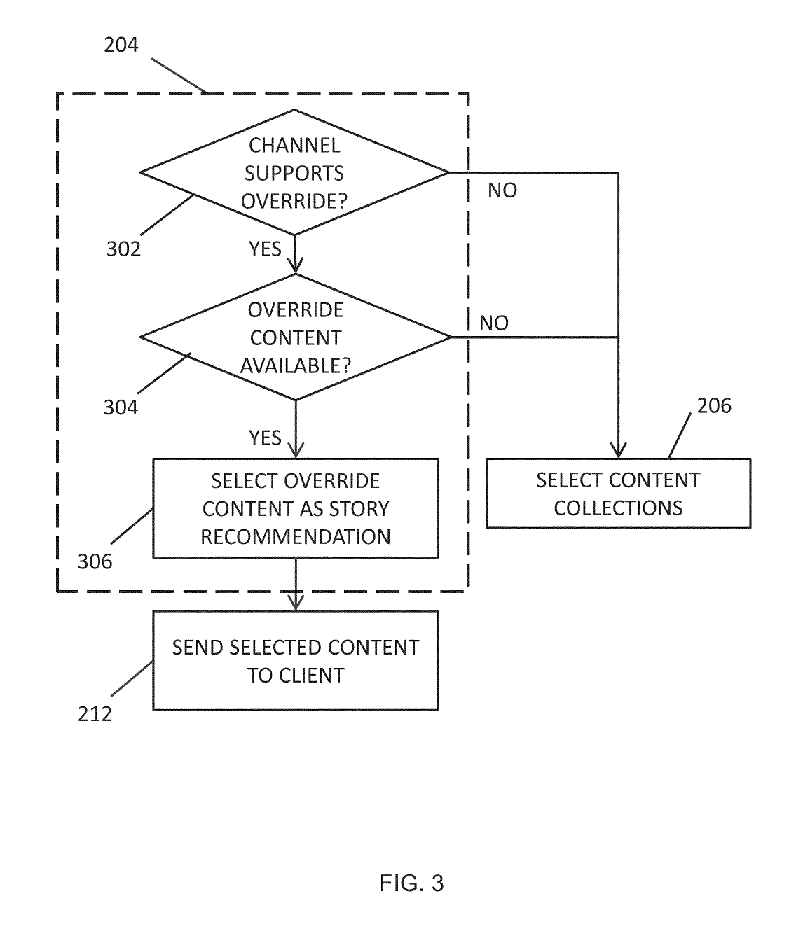

A non-limiting example of how the system 100 determines whether a news override is required is described in further detail in connection with FIG. 3. If a news override (or other type of override) is required (step 204: Yes), the system 100 selects the updated news as the content recommendation to send to the connected device 104 of the user (step 212).

On the other hand, if a news override (or other type of override) is not required (step 204: No), the system 100 selects a content “collection” from among various content collections associated with the content channel (step 206). Initially, an editor of the system 100 pre-configures channels with “collections” or categories of digital content. Radio programs such as All Things Considered, Morning Edition, or Talk of the Nation often air multiple stories or broadcast segments during the program. Accordingly, examples of content collections may include collections of news stories and broadcast segments categorized by radio programs on which the segments originally aired (such as All Things Considered, Morning Edition, or Talk of the Nation). Content collections may also include collections of digital content that have categories associated with the channel. For example, if the user selected a sports channel, the content collections may include segments related to sports talk shows, soccer, football, etc.

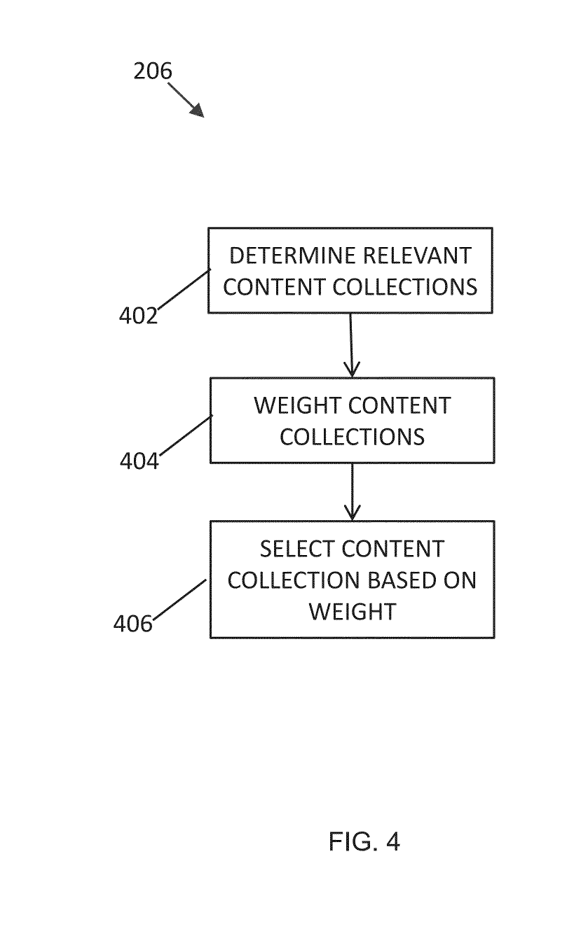

More generally, a content collection is a grouping of digital content, such as stories, that are related by metadata taxonomy. In one embodiment, metadata taxonomies can be used to group content by topic, program, author, musical artist, music genre, reporter, editorial series, book genre, magazine volume and issue, etc. For instance, the system may form a content collection by grouping digital content (e.g., news stories) together that are reported by a particular reporter. The system 100 evaluates content collections that have been associated with the particular content channel selected by the user and selects one of the content collections based on pre-configured probabilities for selecting content collections for the given channel. For example, an editor may decide that, for a selected channel on arts and life, the system should recommend segments 40% of the time from a collection of stories which originally aired on the radio program Weekend Edition Saturday, 35% of the time from a collection of stories which were reported from Boston, Mass., and 25% of the time from a collection of stories which were reported by a certain correspondent. One example of how the system 100 selects a content collection is described in further detail in connection with FIG. 4.

Once the content collection is selected, the system 100 determines story candidates from the selected content collection (step 208). For example, each content collection may have a large number of story candidates, and the system 100 determines which story candidates from the collection should be selected for potentially sending to the connected device 104 of the user. In some embodiments, for any given content collection, some story candidates may be grouped into recommended stories that an editor believes are important (i.e., editor-prioritized story candidates), and other story candidates may be grouped into stories that are recommended, or personalized, for the user (i.e., personalized story candidates). In this scenario, the system 100 may determine whether to deliver an editor-prioritized recommendation (with editor-prioritized story candidates) or a personalized recommendation (with personalized story candidates).

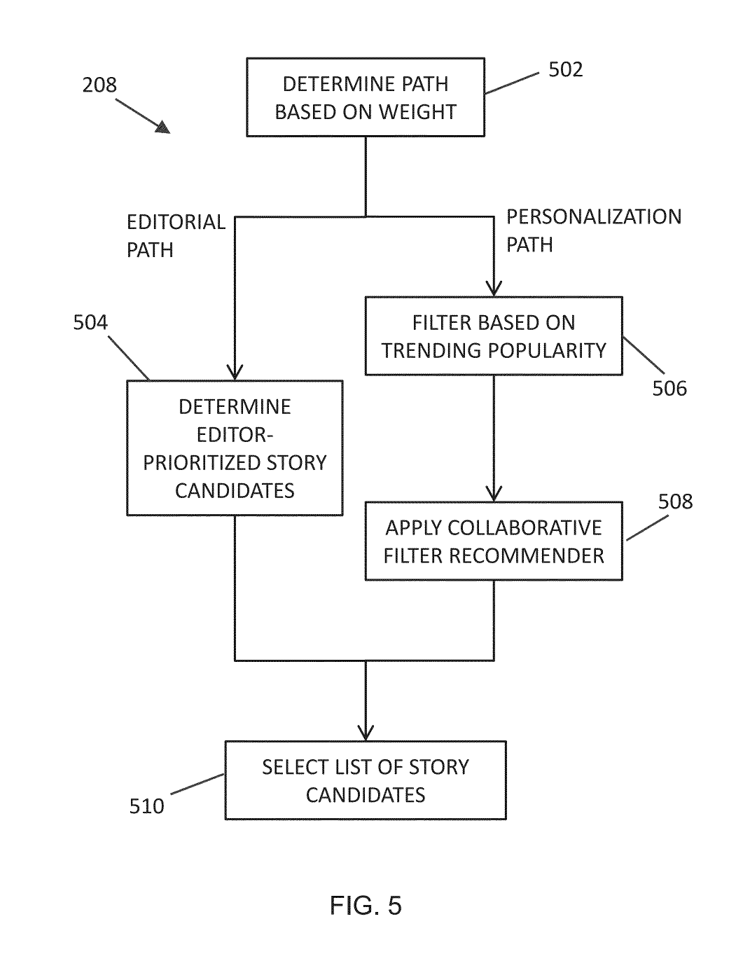

For example, an editor may previously have ranked or prioritized certain stories highly in a content collection for the Morning Edition news. However, the system 100 may also infer that a user might be more interested in a personalized recommendation of other stories in the content collection, even if an editor has previously ranked the other stories with a lower priority. The system 100 can determine a list of potential story candidates for recommendation based on pre-configured probabilities indicating weights or desired recommendation frequencies of editor-prioritized content versus personalized content. For example, an editor might configure a channel such that for a content collection containing segments featuring a particular reporter, for 55% of the time the system 100 should recommend editor-prioritized content, and for 45% of the time the system 100 should recommend personalized content. One example of how the system 100 determines the list of story candidates for recommendation to the user is described in further detail in connection with FIG. 5.

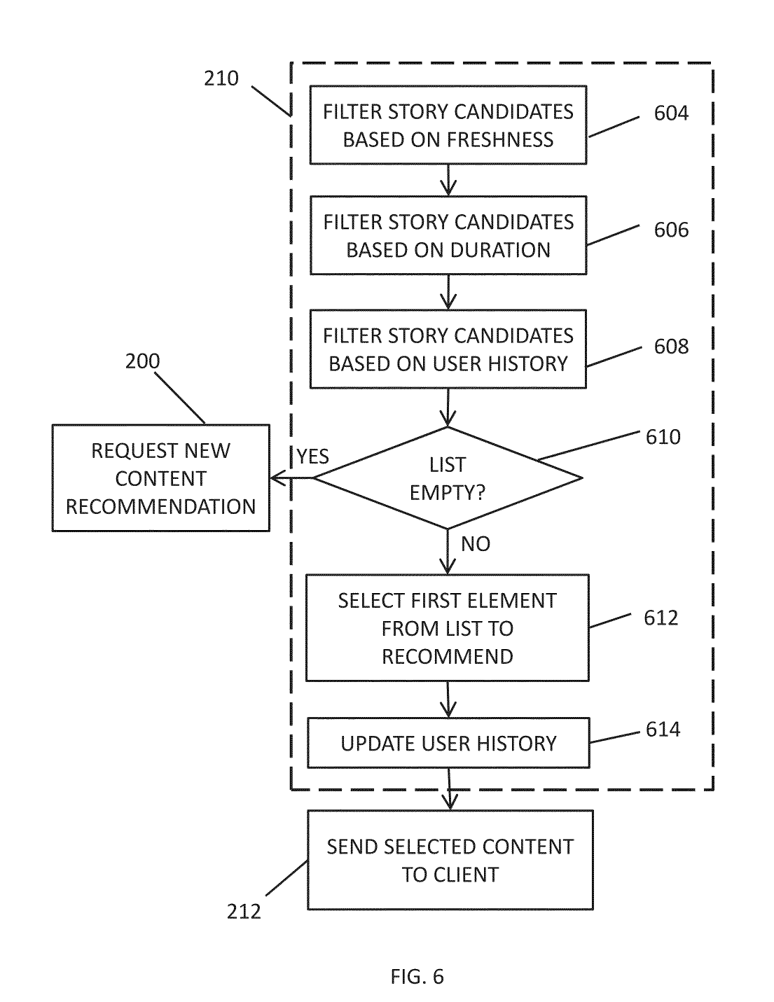

After the list of story candidates is determined, the system 100 filters the list based on content filters to reduce the number of story candidates to a desired number of candidates (step 210). In some embodiments, the system 100 applies customized filters to remove story candidates from the list based on user history, duration, and freshness. For example, the system 100 may determine not to recommend stories that the user has previously received, stories that have a duration that is longer than a certain length (e.g., longer than one hour), or stories that are not current enough (e.g., more than one month old). Some embodiments allow the editors and/or users to configure the filters for removing certain stories from the list of candidates for a selected content channel. One embodiment showing how the filters are used to tailor the list of story candidates is described in further detail in connection with FIG. 6.

Once the list of story candidates is determined, the system 100 sends the highest-ranked story candidate in the list to the user's connected device 104 as the selected story recommendation (step 212). Moreover, in another example, the list of story candidates corresponds to a playlist of songs, television or radio shows, or streaming audio segments, and the system 100 sequentially sends each song or segment to the connected device 104 based on the priority of each song or segment. Of course, the system 100 may select and send digital content to the device based on one or more criteria besides priority.

In some implementations, each time the system 100 receives a user request for a content recommendation (step 202), it repeats the process 200.

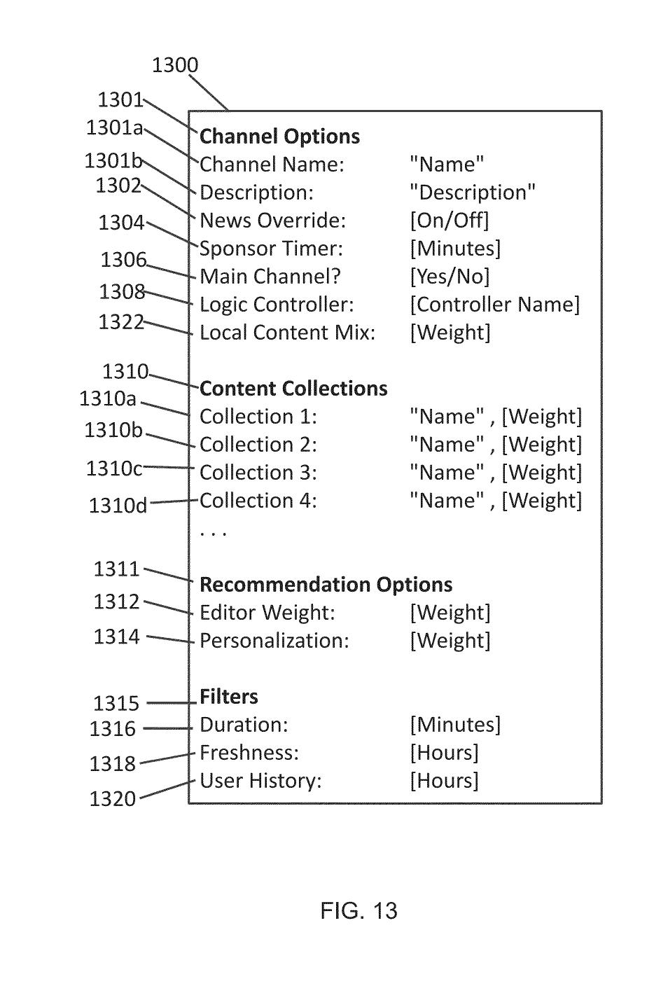

In one implementation, the system allows editors, administrators, and/or users of connected devices to configure various parameters or attributes that the system uses for content recommendation. Examples of attributes can include randomization probabilities or weights for selecting content collections, selecting editorial versus personalized recommendation paths, and selecting story candidates, filter thresholds for filtering story candidates, content collections for aggregating story candidates, and the extent of the news update (or other type of) override. These attributes can be configured during the creation of a content channel by an editor, administrator, or user, or configured after the channel is created. Specific, non-limiting examples of attributes are described in further detail in connection with FIG. 13.

FIG. 3 illustrates an example of the process 204 (FIG. 2) that the system 100 uses to determine whether to apply a news update override. As noted above, with reference to FIG. 2, if a news update should be delivered, the system 100 skips the steps of selecting content collections (step 206), determining story candidates (step 208), and filtering story candidates (step 210). In some embodiments, updated news can include periodic news summaries, breaking news coverage, emergency broadcast information, or planned live coverage of news and cultural events. In further embodiments, some content channels configured with a news update override can deliver a periodic (e.g., an hourly) newscast summary whenever a new newscast becomes available. Of course, as noted above, the override feature is not limited to delivering news or urgent information to a user's connected device 104, and the system 100 may utilize an override feature to deliver other types of content.

In the news override process 204, the system 100 determines whether the content channel selected by the user has been configured by an editor, administrator, and/or user to support the news update override feature (step 302). For example, an editor might determine that a music channel should never be interrupted to recommend breaking news or other updated broadcast segments. If the content channel does not support the override feature (step 302: No), the process 204 proceeds to select the content collections (step 206) (FIG. 2). If the channel supports the override feature (step 302: Yes), the system 100 determines whether any news override content is available (step 304). If news override content is not available (step 304: No), the process 204 proceeds to select the content collections (step 206) (FIG. 2). If news override content is available (step 304: Yes), the system 100 selects the override content as the content recommendation for the user's client device 104 (step 306). Then, the system sends the selected content to the client device 104 (step 212).

FIG. 4 illustrates an example of the process 206 (FIG. 2) that the system 100 performs for selecting content collections. Content collections can include broadcast segments categorized by radio show, such as Wait Wait . . . Don't Tell Me!, or categorized by genre, such as arts, lifestyle, sports, and technology. More generally, a content collection may be a grouping of stories that are related by metadata taxonomy. Examples of metadata taxonomies or story groupings can include stories grouped by topic, program, author, musical artist, music genre, reporter, editorial series, book genre, magazine volume and issue, etc. Content collections may include content that is broadcast by national stations, content broadcast by local stations, or other third-party content. Collections may be themed according to content series, program, topic, or other aggregating factors. In some embodiments, the system 100 may allow the editor or user to rank or order the content in a collection by priority or by reverse chronological date (ranking or ordering newer content higher than older content). The system 100 may also allow editors or users to blend multiple content collections in a channel according to programming and audience research, content affinity score, listening mood, format, and desired channel style. As described earlier, programming and audience research includes conversations and focus groups with listeners and consumers of competitive media that discover qualitative connections between otherwise seemingly disparate content. Content affinity score measures interest that an audience of one radio program might have in the content of another radio program. Content affinity score can be based on listener surveys. Listening mood measures how an individual's content preferences change based on time of day, day of the week, or other factors. Format refers to a broad content categorization often associated with an entire channel or radio station. For example, some radio stations can be considered classical music stations and other stations can be considered talk format stations. Desired channel style refers to rules that editors or administrators apply to content, such as a desired length of all stories in a channel, the immediacy or timelessness of the content, and the appropriateness of an interruption for updated content, such as breaking news or a live concert.

Each channel that the user selects may include one or more content collections. A channel may draw content recommendations from its underlying content collections in equal or varying proportions. For example, for a selected channel on the arts, the system 100 may draw content recommendations from its underlying content collections in equal proportions by recommending segments 33.3% of the time from a collection of stories which originally aired on the radio program Weekend Edition Saturday, 33.3% of the time from a collection of stories which were reported from Boston, Mass., and 33.3% of the time from a collection of stories which were reported by a certain correspondent. Alternatively, the system 100 may draw content recommendations in varying proportions by recommending segments 70% of the time from a collection of stories which originally aired on the radio program Weekend Edition Saturday, 20% of the time from a collection of stories which were reported from Boston, Mass., and 10% of the time from a collection of stories which were reported by a certain correspondent. Each content collection within a channel has an individual frequency or weighting score that affects how often the content collection is selected within a channel. The system 100 allows editors, administrators or users to specify content collections and weights for the content collections in each channel by using a configuration tool. One embodiment of the configuration tool is described in further detail in connection with FIG. 13.

As shown in FIG. 4, in one embodiment, the system 100 selects the content collections (step 206 (FIG. 2)) by determining relevant content collections for the user of the connected device 104 (step 402). The system 100 may determine relevant content collections by loading the content collections and their associated weights or recommendation frequencies from the channel configuration tool (FIG. 13). Then, the system 100 applies various weights to the content collections (step 404). For example, assume that the user selects a channel about science, and the configuration tool has configured the science channel to have the following content collections {in brackets} and corresponding weights (in parentheses): {Morning Edition (0.5)}, {Weekend Edition Sunday (0.3)}, {All Things Considered (0.1)}, and {Wait Wait . . . Don't Tell Me! (0.1)}. In this instance, the system applies weights to the content collections so that there would be a 50% probability that the system 100 recommends broadcast segments (i.e., story candidates) from Morning Edition, a 30% probability that segments from Weekend Edition Sunday are selected, a 10% probability that segments from All Things Considered are selected, and a 10% probability that segments from Wait Wait . . . Don't Tell Me! are selected. In other embodiments, instead of weighting the content collections for a channel based on the weights entered in the configuration tool (FIG. 13), the system 100 can use weighted randomization to randomly apply weights to the collections.

In some embodiments, if national and local station content collections (or other third-party content collections) are present, the system 100 can use a weighted randomization or recommendation frequency to determine a content provider to use for determining relevant content collections. Example content providers can include providers of national content (such as NPR), providers of local content (such as local radio stations), and providers of third-party content (such as lecture recordings or musical performances from a concert hall). For example, an editor might configure a given channel to select content collections 75% of the time from national content, such as NPR content, 20% of the time from local content, such as local radio station content, and 5% of the time from third-party content, such as concert hall content. After applying the weights to the content providers, the system 100 selects one of the content collections based on the weights (step 406). In other embodiments, it may select multiple content collections based on the weight.

FIG. 5 illustrates an example of the process 208 (FIG. 2) that the system 100 performs for determining a list of story candidates for a selected content collection. As explained above, in some implementations, within a content collection, some story candidates may be grouped into recommended stories that an editor believes are important (“editor-prioritized story candidates”), and other story candidates may be grouped into stories that are recommended, or personalized, for the user (“personalized story candidates”). In this scenario, the system 100 determines whether to follow an “editorial path” and select editor-prioritized story candidates or to follow a “personalization path” and select personalized story candidates.

Initially, the system 100 determines which path to follow based on the weightings of the paths (step 502). As in the case of the weighted content collections described in conjunction with FIG. 4, the editor, administrator, and/or user can use the configuration tool (FIG. 13) described below to set the weights of each path. Alternatively, the system may apply a weighted randomization to determine which path to follow. In yet another embodiment, the system 100 may assign weights to the paths based on a user's previous history in accessing content, empirical data, or other information. For example, based on this data or information, the system 100 may determine that a user likely is more interested in a story candidates selected via the personalization path instead of the editorial path (or vice versa). After the weights are assigned to the paths, the system 100 selects one of the paths based on the weights.

If system 100 selects the editorial path, it uses an editorial recommendation engine to select a list of highest-ranking story candidates for the selected content collection (step 504). For example, the selected content collection might contain a list of stories {in brackets} and their associated rankings or priorities (in parentheses), such as {In Key Senate Races, Outside Groups Outpace Candidates' Ad Spending (0.83)} and {The Night a Computer Predicted the Next President (0.67)}. Thus, in this example, the story, “In Key Senate Races, Outside Groups Outpace Candidates' Ad Spending,” has a higher ranking than the story, “The Night a Computer Predicted the Next President.” In some embodiments, an editor, administrator, and/or user may pre-assign or pre-configure each story candidate with a rank or priority using the configuration tool (FIG. 13) or similar tool. Alternatively or additionally, the list of story candidates may be ranked or ordered according to reverse chronology in which newer stories have higher ranks or priorities than older ones. Then, the system 100 uses the editorial recommendation engine to select a list of story candidates based on their rank or priorities (step 510). In one embodiment, the candidates are ordered by using the rankings of the candidates to determine a probability that each candidate will be selected to be next in the list. In another embodiment, the candidates are ordered in the list from the highest ranking to the lowest ranking.

If the system 100 selects the personalized path, it retrieves the currently trending popular set of story candidates for the selected content collection (step 506). In one example, the currently trending popular stories refer to stories which other users consider to be popular at the moment. The system may determine how popular a story is based on (1) how often it is sent to, read by, or listened to by a user, (2) feedback from users (who may manually input a rank or grade for the story after reading or hearing it), and/or (3) data, which may be similar to “Nielsen” ratings, and/or (4) other types of data, including but not limited to, the data discussed above. In some embodiments, the system 100 uses direct measures of trending/popularity for the content collection. In some embodiments, the system 100 can measure the popularity of stories in an indirect manner that the recommendation system cannot influence. For example, if audio content is being broadcast or delivered, indirect popularity measures may include web page downloads, social media, shares or recommendations, or audio downloads served on a separate platform. The popularity of a story may be assigned a weighting or a ranking indicating how popular the story is.

The system 100 uses the currently trending popular set (from step 506) as an input pool for the collaborative filtering algorithm or recommender (step 508). The collaborative filtering algorithm recommends stories according to other stories which other listeners have rated highly, or other stories which the user requesting content has previously rated highly. In one example, unlike the trending popularity analysis described earlier, the collaborative filter may use factors other than popularity among the mass user audience to determine recommendations. For example, the collaborative filter can use previous ratings of other content from the user, previous ratings of the story candidate from other users, and previous ratings of other content from other users, where the other content is related to the content collection or to the story candidate being evaluated by the system 100. Accordingly, the recommendation can include stories where “listeners who liked this story also liked” certain other stories.

Traditionally, collaborative filtering systems have shortcomings when applied to news and other current content. While music, books, and movie content are mostly timeless or “evergreen,” most news and talk radio content are timely and have a short shelf-life. Unlike recommendation systems for book or movie content, news content includes a mix of timeless and timely content. One news story that is a good recommendation today may continue to be a good recommendation next year. On the other hand, another news story that is a good recommendation today may become a stale recommendation tomorrow.

Conventional collaborative filtering systems are unable make this predictive distinction because collaborative filters are based solely on measures of past popularity. Therefore, a content recommendation system, in which news, talk radio, and other potentially time sensitive content are types of possibly recommended content, cannot purely rely on these types of collaborative filtering systems.

Accordingly, in one non-limiting embodiment, the system 100 filters the overall set of currently trending popular story candidates by classification. Filtering by classification refines recommendations for individuals who might exhibit different expectations at different times by ensuring that only popular stories for the selected content collection are returned. For example, a user might be a computer programmer and interested in jazz music. In this instance, if the selected content collection is about technology, the system 100 uses set logic to filter currently popular stories that are classified as “technology.” If the selected content collection is about jazz, the system 100 uses set logic to filter currently popular segments or stories that are classified as “jazz.” The system 100 then uses set logic to compare this resultant ordered set of popular story candidates with the collaborative filtering recommendations to remove any recommendations from collaborative filtering which are not also in the resultant ordered set of popular stories (step 508). For example, for a content collection about technology, the system 100 compares popular technology story candidates to remove recommendations from the collaborative filtering which are not also in the resultant ordered set of popular technology stories. For a content collection about jazz, the system 100 compares popular jazz segments to remove recommendations from the collaborative filtering which are not also in the resultant ordered set of popular jazz segments. Accordingly, the resulting list of rank-ordered story candidates selected by the collaborative filter only contains stories that are also members of the set of currently popular stories. The popularity-filtered collaborative filter then selects the resulting list of rank-ordered story candidates for the given content collection (step 510).

In some embodiments, the system 100 uses different collaborative filtering for new users. New users have not yet rated any content, and therefore, in some instances, the collaborative filter may not yet be able to make a recommendation based on the user's previous ratings. In this case, and in any case where the collaborative filter cannot make a recommendation, the collaborative filter may simply recommend the highest-ranking story from the trending popularity filter without performing additional collaborative filtering.

Some news content expires quickly, and therefore, the system 100 creates a steady influx of new ratings into the recommendation system to avoid running out of stories to recommend. While editor-recommended content bypasses the personalization engine, the system 100 sends user ratings of editor-recommended stories into the collaborative filter recommender system so that new editorial stories quickly accumulate a ratings profile for future recommendations.

The popularity set also ensures a steady stream of new trending popular stories which can be rated and recommended via the collaborative filter. Because the editorial path and the personalization path both contribute user ratings to the collaborative filter database, the system 100 receives a steady influx of new content stories to recommend.

In some embodiments, the collaborative filter may store implicit and explicit ratings. For example, the system 100 may infer implicit ratings from user behaviors, such as user interface actions. For instance, a user who skips a story is implicitly rating a story as average or below average. Furthermore, the system 100 allows an editor, administrator, and/or user to tune the ratings assigned to user behaviors. For example, as described below, if a user activates a skip button of a user interface to skip a song, it may decrease the rating of the song less than if the user activates a thumbs down icon. Namely, the user may have other reasons for skipping the song beside not liking the song, whereas there is a much higher probability that the user does not like the song if he or she activates the thumbs down icon. For a music channel, an editor, administrator, and/or user may tune the ratings assigned to the skip button to use increments of 0.5 to lower ratings instead of 1.0. Tuning these ratings would reflect the characteristic that users may be more likely to skip longer segments which are more common in a music channel. Tunable ratings also allow an editor, administrator, and/or user to improve the overall accuracy of recommendation.

In addition to implicit ratings, the system 100 may allow users to indicate explicit collaborative-filter-based ratings. A user who clicks a “thumbs up” icon or a “more like this” button in a user interface is explicitly rating a story highly. Additionally, the system 100 can allow a user to indicate explicit classification-based ratings. For example, the system 100 can use explicit ratings to indicate that a user would like more of a particular thematic content collection, or that a user would like fewer stories having a certain characteristic. Examples of thematic content collections include, but are not limited to, stories by a certain reporter or stories about a particular topic, such as Afghanistan. Additional examples of characteristics for which a user may explicitly indicate a preference include, but are not limited to, stories with photos, stories that are interviews, or stories about books or music works.

FIG. 6 illustrates an example of the process 210 (FIG. 2) that the system 100 performs for filtering story candidates. Filters utilize set logic to remove story candidates that do not meet criteria for a particular channel or for a particular user. The system 100 filters the rank-ordered list of story candidates. Examples of filters can include filtering story candidates based on freshness (step 604), filtering story candidates based on duration (step 606), and filtering story candidates based on user history (step 608).

Filtering story candidates based on freshness (step 604) specifies a threshold for how current a story must be to appear in the selected content channel. In some embodiments, the freshness filter can be based on elapsed time and metadata. Elapsed time can include a counter of time (e.g., minutes and/or hours) since a story was published. Also, metadata can include editor-tagged attributes that allow an editor to indicate that a story is either time-sensitive or more timeless.

Filtering story candidates based on duration (step 606) specifies an upper limit of story length (e.g., minutes) for a given channel. A duration filter allows editors or administrators to help preserve a mood or style of a content channel. For example, some channels may benefit from longer content, while some channels may benefit stylistically from shorter content. A news channel might allow recommendations of segments of up to six minutes in length, while a music channel or television show channel might allow recommendations of segments of up to an hour in length.

Filtering story candidates based on user history (step 608) specifies how often a story candidate may be recommended again after the user has already received a recommendation for it once. In some embodiments, the system 100 never recommends a story that it has previously recommended to the user. In one implementation, the system 100 allows users to search their playlist history and listen to stories more than once, but avoids recommending the same story candidate more than once. In other examples, editors can customize music or other cultural channels to have a different user history setting that allows a story candidate to be recommended again after a specified interval of time elapses since the user last received the candidate.

After the system 100 has applied the filters in steps 604, 606, and 608, the list of story candidates has been reduced and is in ranked order. After applying the filters, it is possible that the system 100 has removed all story candidates from the list. For example, all story candidates in the list may have been too long or too old to recommend to the user. Accordingly, the system 100 checks whether the story recommendation list is empty (step 610). If the list is empty (step 610: Yes), there are no story candidates for the system 100 to recommend. Accordingly, the system 100 requests a new content recommendation according to the process 200 (FIG. 2).

If the list contains at least one story candidate (step 610: No), the system 100 selects the first story from the list to recommend (step 612) and updates the user history (step 614). For example, the system 100 may log the story recommendation in the user's history, and the log can be later used in the user history filter or displayed on the user interface as a personal listening history for the user. Subsequently, the system 100 sends the story to the user's client device as the story recommendation (step 212). Of course, in step 612, the system 100 does not have to send the first story in the list to the user in step 212 and instead, may send another story in the list based on various criteria and/or analysis.

The system 100 can also update the user history in response to other user events. When a story that is sent to the user ends, or when the user advances the story (e.g., by activating a skip button), the system 100 can update the user history with any implicit or explicit ratings to be used in later collaborative filter engine recommendations. The system 100 can then receive the next content request from the user's connected device 104, which restarts the content recommendation process 200.

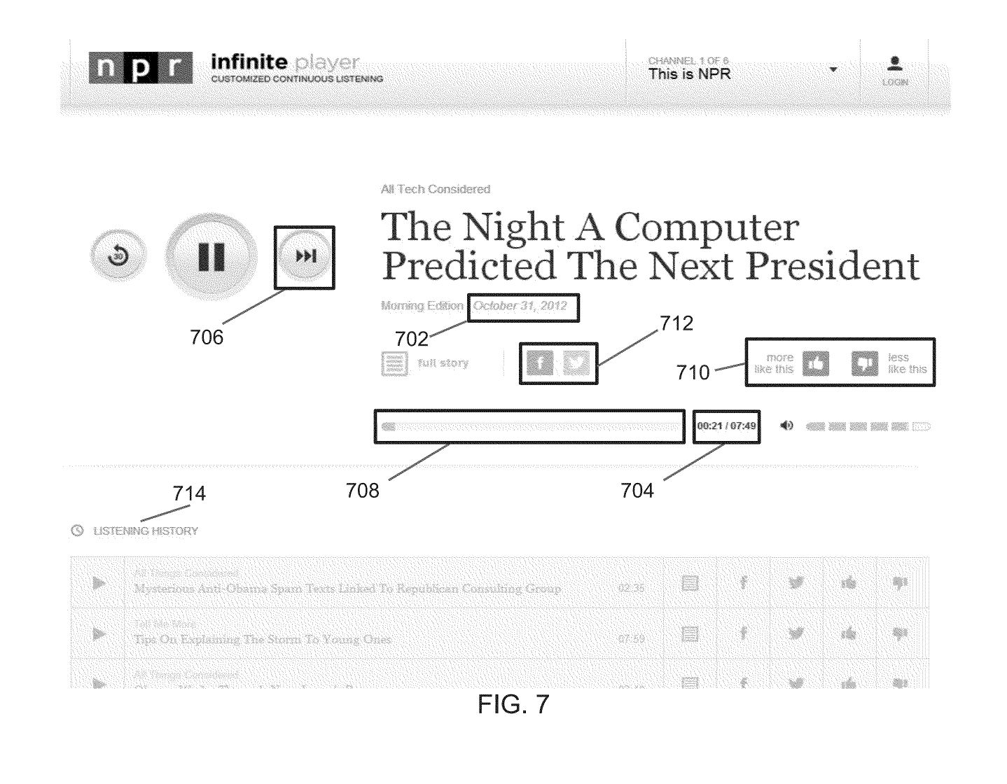

FIG. 7 illustrates an example of a screenshot of a user interface for consuming recommended digital content. In one embodiment, this user interface is displayed on the user's connected device 104 (FIG. 1). The user interface illustrates graphical elements and content attributes used as content filter inputs, and graphical elements used as rating inputs.

Graphical elements used as content filter inputs include the story date 702, an audio length 704, and a user history 714. The story date 702 illustrates a date and a time (not shown) when the story originally aired. In some embodiments, the system 100 can use elapsed time since the story (song, show, etc.) aired or was published as an input into the freshness filter 604 (FIG. 6). In one embodiment, the freshness filter 604 prefers recommending stories that aired more recently and avoids recommending stories which aired less recently. In some implementations, the system 100 uses the audio length 704 as an input to the duration filter 606 (FIG. 6) to filter out stories that are longer than a desirable length for a content channel. The user history 714 is a graphical display showing the stories or content that the user has received from the system 100. In some embodiments, this user history 714 is used for both collaborative filter recommendations and as an input into the user history filter 608 (FIG. 6).

Graphical elements that may also be used as rating inputs into the collaborative filter engine or recommender 508 (FIG. 5) include implicit and explicit ratings. The skip button 706, listen duration 708, and share buttons 712 are examples of implicit ratings of user approval or disapproval. A user who uses the share buttons 712 to post about a story using social media is implicitly rating a story highly. A user who uses the skip button 706 to skip a story is implicitly rating a story as average or below average. If a user listens to the entire duration of a story, the user is implicitly rating the story highly.

The “more like this” and “less like this” buttons 710 are examples of explicit ratings. A user who clicks the “more like this” button 710 is explicitly rating a story highly by indicating that the user wants more stories like the currently playing story. For example, the system 100 can use explicit ratings to indicate that a user would like more of a particular thematic content collection, or that a user would like fewer stories of a certain characteristic. An example of thematic content collections can include stories by a certain reporter or stories about a particular topic, such as Afghanistan. Examples of characteristics can include stories with photos, stories that are interviews, or stories about books or music works. In further embodiments, the “more like this” and “less like this” buttons 710 can provide a more granular display for the user to indicate the specific theme or characteristic which he or she is rating.

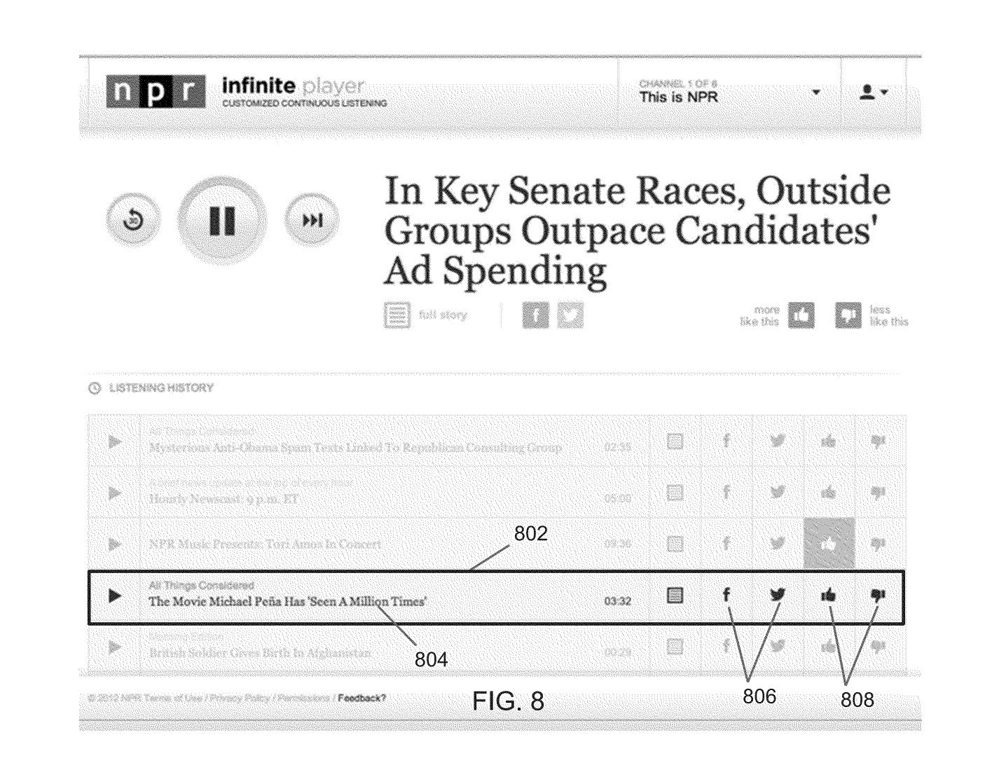

FIG. 8 illustrates an example of a screenshot of a user interface for displaying listening, receipt, or consumption history of content. This history is a graphical representation of the user's history as it exists in the present recommendation system 100. As shown in the graphical element 802, the system 100 allows users to view past content recommendations, (e.g., the segment “The Movie Michael Pena Has ‘Seen A Million Times’” on the All Things Considered program 804) and play them again. Furthermore, the history may contain inputs that adjust the implicit ratings of the content, such as the share buttons 806, and inputs that adjust the explicit ratings of the content, such as the “more like this” and “less like this” buttons 808.

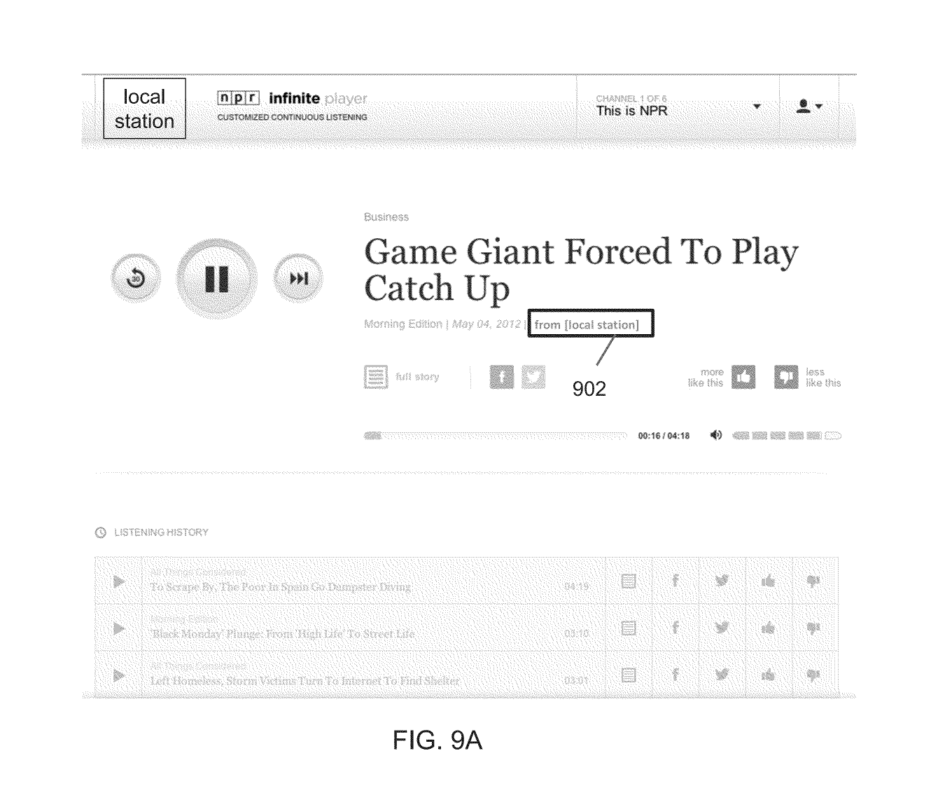

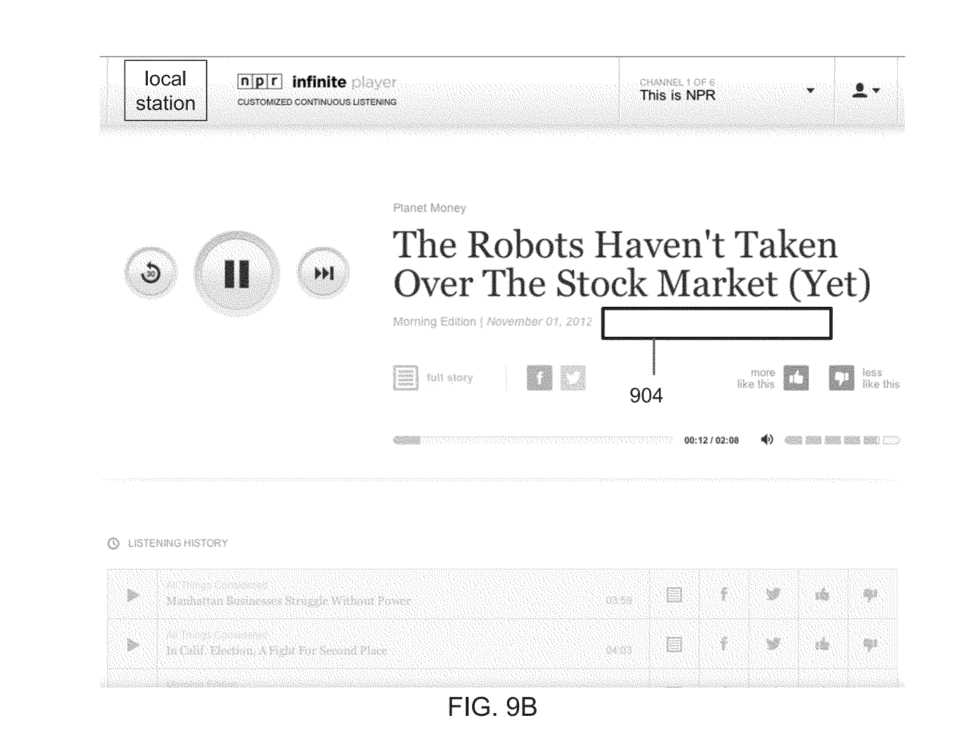

FIGS. 9A-B illustrate examples of screenshots of a user interface for blending national and local content. FIG. 9A illustrates an example of a screenshot when the connected device 104 plays a local station story that was recommended via a local station content collection. The local station credit 902 displays a source of the local station story. The source can include a textual description such as a station name, an icon, a logo, or other graphical display representing the local station. FIG. 9B illustrates an example of a screen shot when a device 104 plays a national story that was recommended. The white space 904 in FIG. 9B indicates that the national story lacks a local station credit because it is a story from a national content collection. Of course, the white space 904 could contain an icon, message, or other indication indicating that the story is a national story.

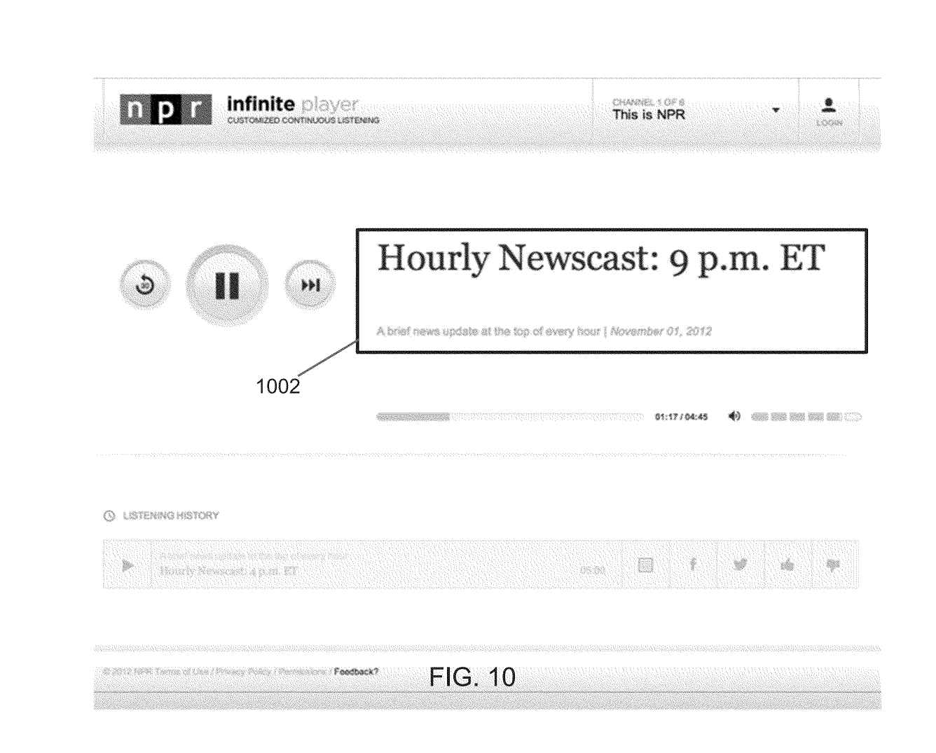

FIG. 10 illustrates an example of a screenshot of a user interface that is displayed on a user's connected device when a news override story is received. For example, as described earlier, the system 100 may have select an hourly broadcast story according to the news update override process 204 (FIGS. 2-3). The system 100 allows an editor and/or administrator to configure content channels to play an hourly newscast 1002 whenever the hourly newscast becomes available. Of course, if a different news override or other type of override story or content is being received, the information in screenshot in FIG. 10 will change to identify the different override content.

To recommend content for a user, the system 100 allows the user to select among varying content channels of interest. In some embodiments, content channels may vary based on factors such as content freshness and duration. For example, the system 100 may allow an editor and/or administrator to configure a news channel to recommend content that is no older than eight hours and no longer than six minutes. An editor and/or administrator may configure a music performance channel to recommend content that is several years old and up to an hour in length. The system 100 further allows an editor and/or administrator to create, delete, and update content channels.

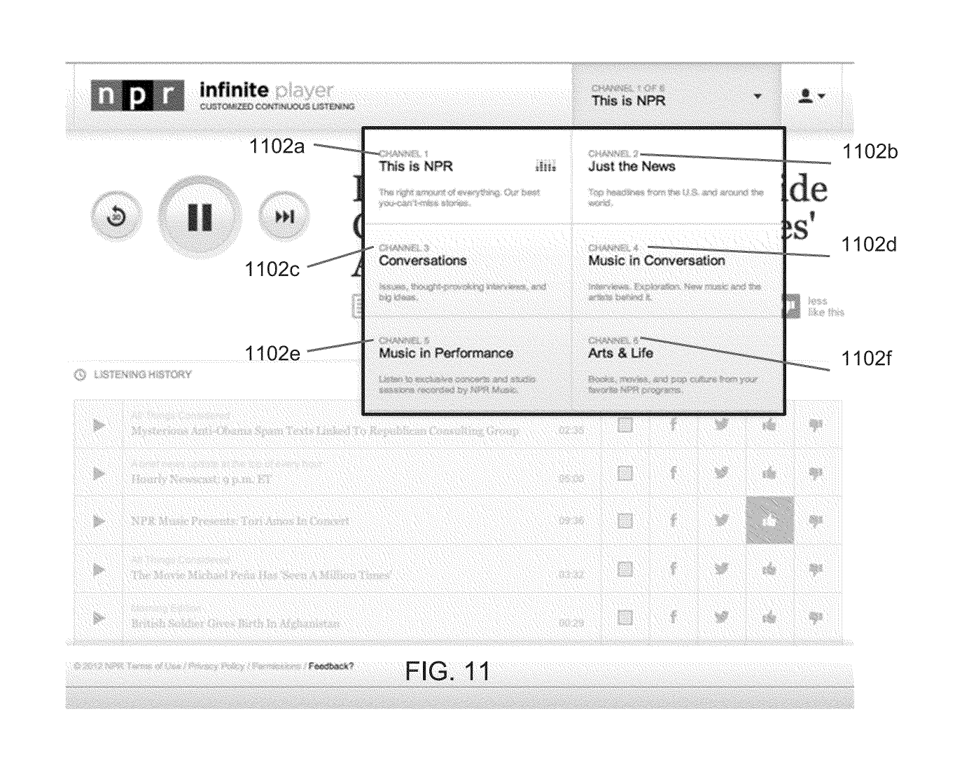

FIG. 11 illustrates an example of a screenshot of a user interface of a connected device 104 for a multichannel user experience. The user interface illustrates six existing channels. These channels include a default main channel 1102a, a news channel 1102b, a conversations/interview channel 1102c, a music discussion channel 1102d, a music listening channel 1102e, and an arts and life channel 1102f. In some implementations, the channels displayed on the user interface can be selected or configured by the user, editor, or administrator. Moreover, the display channels may be determined via a random or pseudo-random process or may be automatically selected and displayed based on criteria or preferences that user, editor and/or administrator input. In yet another example, the displayed channels may be automatically selected based on demographic data, channel popularity and/or freshness data, or other criteria that is the same as or similar to the criteria discussed above. In any event, in one example, the user can select one of the channels 1102 via the connected device 104 to send a content request to the system 100 and initiate the process 200 (FIG. 2).

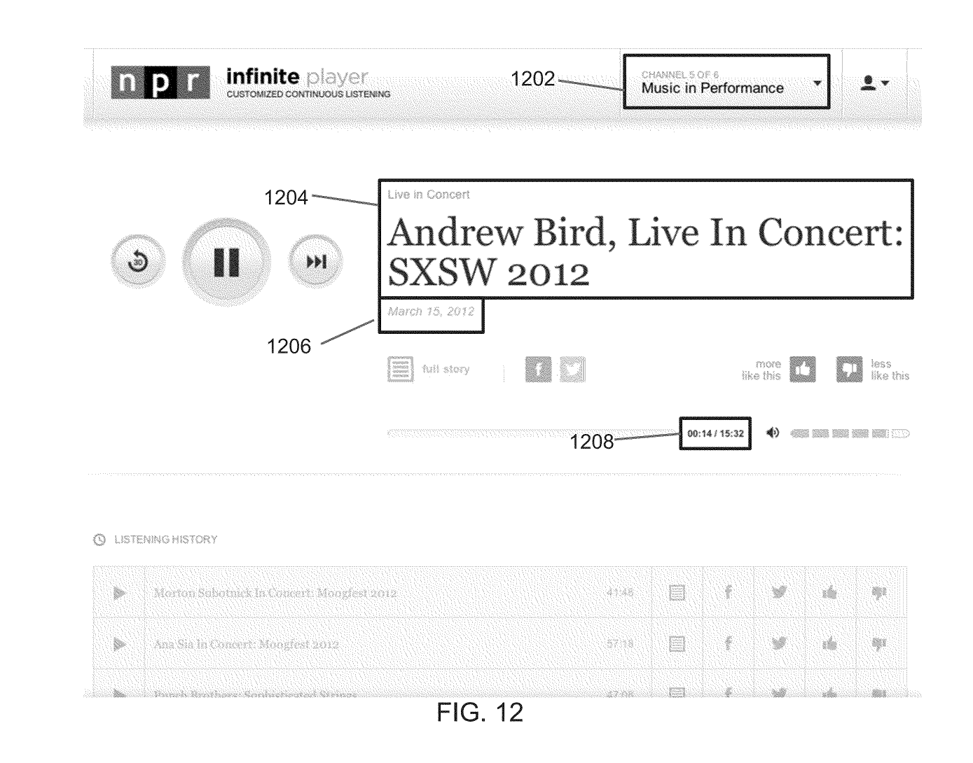

FIG. 12 illustrates an example of a screenshot of a user interface for a music listening channel. The user interface further illustrates that the system 100 is capable of recommending non-news and non-talk content. For example, the user interface includes a channel display name 1202 (e.g., Music in Performance) of the currently selected channel (Channel 5 of 6) and the music story content 1204 (“Andrew Bird, Live In Concert: SXSW 2012). In some embodiments, a music channel may support older content because music content is not time-sensitive. The system 100 allows an editor, administrator, or user to configure this setting for a content channel by configuring the freshness filter 604 (FIG. 6) in general or for the specific channel. The fact that the freshness filter 604 is configured to send older content to the user's connected device 104 is illustrated by the older story date 1206 (e.g., Mar. 15, 2012) in the user interface. A user visiting a music channel may also be receptive to content having a longer duration. In some embodiments, the system 100 allows an editor, administrator, or user to configure the duration filter 606 (FIG. 6), on a per channel basis or in general, to allow the connected device to receive content with relatively long durations. The fact that the duration filter 606 is configured to allow longer content is illustrated by a longer story duration 1208 (e.g., 15 minutes and 32 seconds).

FIG. 13 illustrates an example of a user interface 1300 for the configuration tool (discussed above) for configuring channels. In some embodiments, the system 100 allows editors, administrators, and users to customize channel options, content collections, recommendation options, and filters.

For example, editors and/or administrators may create a new channel (or edit an existing channel) and specify various content inputs, variable recommendation, and filter settings for the channel in the user interface 1300. Initially, an editor may select one or more content collections to include in, or form the basis of, the channel. The system 100 allows the editor to group content thematically into content channels or aggregations that may include topical area, editorial series, program, music or book genre, artist, author, or byline.

FIG. 13 illustrates examples of content configuration options in the user interface 1300. Configuration options can include channel options 1301, content collection options 1310, recommendation options 1311, and filter options 1315. The channel options 1301 can include a channel name (or number) 1301a and description 1301b, a news override option 1302, a sponsor timer option 1304, a main channel indicator 1306, a logic controller configuration option 1308, and a local content mix weight option 1322. The content collection options 1310 can include the name and weights for the content collections 1310a-d corresponding to the channel. The recommendation options 1311 can include an editorial weight 1312 and a personalization weight 1314. The filter options 1315 can include a duration filter option 1316, a freshness filter option 1318, and a user history filter option 1320.

In some embodiments, the system 100 allows editors, administrators, and/or users to configure all or some of the channel options 1301. For example, an editor may set the news override option 1302 to “Yes” to control whether override content can appear on a given channel and may set the option to “No” to prevent override content from displacing or interrupting other requested content. As discussed above, examples of override content include hourly newscasts, latest breaking news segments, or a planned or unplanned live stream. Examples of how the process 200 (FIG. 2) may use the news override option 1302 are discussed above in conjunction with steps 204, 302, 304, and 306 (FIGS. 2 and 3).

The sponsor timer option 1304 includes a threshold that controls how often (e.g., in minutes) a content channel should transmit a commercial or sponsorship message. In further embodiments, during breaking news events, the system 100 allows an editor or operator to disable the sponsor timer option 1304 (or set the option to zero) so that sponsor messages do not appear at all. The main channel indicator 1306 indicates whether the editor or administrator intends the current content channel to be a default main channel. The logic controller configuration option 1308 allows an administrator or editor to implement custom classes or programming to override rules such as “never broadcast the same story twice” and “allow user to use the skip button indefinitely.” The local content mix weight option 1322 allows an editor or administrator to configure the relative amount of local content versus national content or third-party content to broadcast. In one implementation, the option 1322 may include a percentage weight indicating what percentage of content should be local content and not nation or third-party content.

In some embodiments, the system 100 allows editors or administrators to configure content collections by adjusting or setting the content collection options 1310. In one example, the editors or administrator can use the user interface 1300 to assign each content collection 1310a-d for a given channel a particular name and a weighted score. The weighted score (or recommendation frequency) roughly corresponds to a percentage of overall story candidates that should be recommended from each collection 1310a-d for the given channel, as discussed above in conjunction with step 206 (FIGS. 2 and 4).

In some embodiments, the system 100 allows editors and operators to add content collections from local stations or other third-party content sources. The system 100 allows editors to express the overall percentage of stories intended to come from local stations as a weighted score. If multiple content collections 1310a-d are present, the system 100 allows editors or operators to give each content collection a weighted score to represent its constituent percentage. Examples of how the process 200 (FIG. 2) may use the content collection options 1310 are discussed above in conjunction with steps 206, 402, 404, and 406 (FIGS. 2 and 4).

In some embodiments, the system 100 allows editors or administrators to configure recommendation options 1311. For example, editors may specify a recommendation frequency or weight 1312 representing how often the system 100 should follow an “editorial path” (FIG. 5) and select editor-prioritized story candidates to send to the user's connected device 104. Editors may also specify a recommendation frequency or weight 1314 representing how often the system 100 should follow a “personalization path” (FIG. 5) and select personalized story candidates to send. In one implementation, the recommendation frequency for each option 1312 and 1314 is illustrated in the user interface 1300 as a weighted score. Examples of how the process 200 (FIG. 2) may use the recommendation options 1311 are discussed above in conjunction with steps 208 and 502 (FIGS. 2 and 5).

In some embodiments, the system 100 allows editors or administrators to configure filters by adjusting or setting the filter options 1315 in the user interface. For example, an editor or administrator can configure the freshness filter 604 (FIG. 6) by adjusting the freshness filter option 1318. In one implementation, the option 1318 includes a maximum threshold (e.g., in hours) indicating how current the content must be to remain in the list of story candidates. The duration filter 606 (FIG. 6) can be configured by adjusting the duration filter option 1316. In one example, the option 1316 includes a threshold (e.g., in minutes) indicating that content must have a duration less than the threshold to remain in the list of story candidates. The user history filter 608 (FIG. 6) can be configured by adjusting the user history filter option 1320. In one embodiment, the option 1320 includes a threshold (e.g., in hours) indicating the time that must have elapsed before content, which was previously sent to the user's connected device 104, can be sent again to the device 104. Examples of how the process 200 (FIG. 2) may use the filter options 1311 are discussed above in conjunction with steps 210, 604, 606, and 608 (FIGS. 2 and 6).

In some embodiments, the system 100 can support user-generated content channels. While the full range of channel configuration options can be complex, the system 100 may offer a simplified version to users who wish to create and share their own content channels. The system 100 can allow editors or administrators to predefine certain filters, such as more complex filters. With the more complex filters predefined, the system 100 can allow users to select one or more content streams and to specify a balance between editor-recommended and personalized content recommendations.

The screenshots and display pages of FIGS. 7-13 are exemplary of user interfaces that may be initiated by embodiments of the present disclosure to perform the functions herein. Other user interfaces may be created that will help with efficiency of data store entry, add additional features, or further facilitate recommending timely digital content to users. Accordingly not all embodiments of such user interfaces have been described herein, but will be apparent to one of skill in the art. Various user interfaces may be used instead of, or in addition to, the user interfaces described herein, and the user interfaces are in no way to be considered limiting to the specification and claims, but are used for exemplary purposes only.

Those of skill in the art would appreciate that the various illustrations in the specification and drawings described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware, software, or a combination depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

Moreover, in the drawings and specification, there have been disclosed embodiments, and although specific terms are employed, the terms are used in a descriptive sense only and not for purposes of limitation. For example, digital content has been described herein as audio news stories for talk radio, but embodiments where the digital content comprises video segments, text stories, or other multimedia content is within the scope of the disclosure (e.g., to create a continuous video broadcast stream or a magazine browsing experience). Moreover, the disclosure has been described in considerable detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

What is claimed is:

1. A computer-implemented method for recommending timely digital content to a user, the method comprising:
receiving a request for a digital content recommendation for a content channel;
selecting a content collection from a plurality of content collections associated with the content channel, wherein the content collection contains a plurality of pre-selected digital content;
determining a plurality of digital content candidates from the selected content collection based on at least one of pre-determined editorial rankings of digital content candidates and recently popular digital content among a plurality of users;
filtering the plurality of digital content candidates to determine at least one recommended digital content candidate, wherein the filtering is based on at least one of a length of a digital content candidate, a date and time associated with the digital content candidate, and whether the user has previously consumed the digital content candidate; and
sending the recommended digital content candidate to a client device.

2. The method of claim 1, wherein the digital content comprises at least one of talk radio segments, news segments, cultural content, music content, audio segments, video segments, and text stories.

3. The method of claim 2, further comprising
aggregating the recommended digital content candidates into at least one of a continuous audio stream, a continuous video stream, a book, a newspaper, or a magazine.

4. The method of claim 1, further comprising
determining whether to override the recommended digital content candidate based on at least one of whether the content channel supports recommending digital content for overriding and whether updated content is available for overriding; and
selecting the updated content as the recommended digital content candidate.

5. The method of claim 1, wherein the determining the plurality of digital content candidates further comprises
determining a path from among a plurality of paths for determining the plurality of digital content candidates based on a pre-configured path weight, wherein the paths include at least one of an editor-prioritized path and a personalized path;
if the determined path is the editor-prioritized path:
determining the plurality of digital content candidates based at least in part on pre-determined editorial rankings of the digital content candidates; and
if the determined path is the personalized path:
filtering an initial plurality of digital content candidates based at least in part on aggregating ratings indicating recently popular digital content among a plurality of users; and
selecting digital content candidates for the plurality of digital content candidates according to pre-determined editorial classifications of the digital content candidates.

6. The method of claim 5, wherein the filtering the initial plurality of digital content candidates further comprises aggregating at least one of explicit ratings and implicit ratings, wherein explicit ratings are gathered from direct user actions in a user interface and implicit ratings are analyzed based on indirect user actions in the user interface.

7. The method of claim 1, wherein the filtering further comprises
determining a list of digital content candidates based on the plurality of digital content candidates;
filtering the list of digital content candidates based on at least one of (i) how recently each digital content candidate was originally published, (ii) a pre-configured categorization of whether the digital content candidate is time-sensitive, (iii) a duration of the digital content candidate, wherein the duration includes a length of running time of the digital content candidate or a length of text associated with the digital content candidate, and (iv) whether the user has previously consumed the digital content candidate;
determining whether the list of digital content candidates is empty;
if the list of digital content candidates is empty,
requesting a new digital content recommendation;
otherwise,
selecting the first digital content candidate in the list for recommendation; and
updating a user history associated with the user to track the recommended digital content candidate.
